(19) United States
(12) Patent Application Publication
(10) Pub. No.: US 2025/0293861 A1
(43) Pub. Date: Sep. 18, 2025

(54) CALCULATION RESULT DISTRIBUTION DEVICE, CALCULATION RESULT PROTECTION SYSTEM, AND CALCULATION RESULT DISTRIBUTION METHOD

(71) Applicant: Nippon Telegraph and Telephone Corporation, Tokyo (JP)

(72) Inventors: Yurika SUGA, Musashino-shi, Tokyo (JP); Takao YAMASHITA, Musashino-shi, Tokyo (JP)

(21) Appl. No.: 18/861,955

(22) PCT Filed: May 10, 2022
(86) PCT No.: PCT/JP2022/019759

§ 371 Date: Oct. 31, 2024

(51) Int. Cl. H04L 9/08; H04L 9/32

(52) U.S. Cl. CPC H04L 9/085; H04L 9/0819; H04L 9/3247

(57) ABSTRACT

A management server (100) includes a common key distribution unit (113) that generates a common key shared by a plurality of output destination servers (201), generates first encrypted data obtained by encrypting the common key for each output destination server (201) by using a public key paired with a secret key individually possessed by each output destination server (201), and distributes the generated first encrypted data to each output destination server (201), thereby causing each output destination server (201) to decrypt the common key; and a data output unit (114) that distributes second encrypted data obtained by encrypting an output value by using the common key to each output destination server (201), thereby causing each output destination server (201) to decrypt the output value.

### TECHNICAL FIELD

The present invention relates to a calculation result distribution device, a calculation result protection system, and a calculation result distribution method.

### BACKGROUND ART

A field-programmable gate array (FPGA) is used for specific processing as a device having both high speed of an integrated circuit and flexibility of rewriting processing content. A service that can use an FPGA via a cloud is known as FPGA as a Service (FaaS).

In FaaS, for example, a process of calculating an output value for an input value from an input device is offloaded from a management server such as a cloud server to an FPGA on a cloud. The FPGA calculates an output value for an input value and sends the calculated output value to the management server.

Since the output value flows on a cloud network, there are security risk such as falsification, and information content needs to be protected. Therefore, Non Patent Literature 1 discloses that a common key generation process and a signature verification process are performed by an FPGA as an architecture for enhancing security in an FaaS environment.

FIG. 17 is an explanatory diagram illustrating a process of distributing an output value D2.

First, a certificate authority (CA), which is a third-party organization, issues a certificate including a public key of a public key/secret key pair generated by an input device 10z used by a service user and an FPGA 300z used by a service provider to both the service user and the service provider. Both the service user and the service provider who have received the issued certificate use the certificate and the secret key thereof to generate a common key CK shared by both in advance.

Next, the FPGA 300z transmits encrypted data CK(D2) obtained by encrypting the calculated output value D2 by using the common key CK to the input device 10z via a management server 100z. The input device 10z can safely obtain the output value D2 by decrypting the received encrypted data CK(D2) by using the common key CK.

### CITATION LIST

### Non Patent Literature

Non Patent Literature 1: Kim, Han-Yee et al. “SafeDB: Spark Acceleration on FPGA Clouds with Enclaved Data Processing and Bitstream Protection.” 2019 IEEE 12th International Conference on Cloud Computing (CLOUD) (2019): 107-114.

### SUMMARY OF INVENTION

### Technical Problem

FIG. 18 is an explanatory diagram of a case where there are a plurality of destination devices of the output value D2.

In FIG. 18, destination devices of the output value D2 are a total of three devices including the input device 10z in FIG. 17 and newly added output destination servers 201z and 202z. Thus, the FPGA 300z needs to separately prepare a common key CK2 shared with the output destination server 201z and a common key CK3 shared with the output destination server 202z in addition to a common key CK1 shared with the input device 10z, and verify a signature.

The FPGA 300z transmits encrypted data CK1(D2) obtained by encrypting calculated output value D2 by using the common key CK1 to the input device 10z via the management server 100z. Hereinafter, in the present specification, data A to be encrypted and a result of encrypting the data A with a key B used for encryption are expressed in parentheses as B(A).

Similarly, the FPGA 300z transmits encrypted data CK2(D2) obtained by encrypting the output value D2 with the common key CK2 to the output destination server 201z, and transmits encrypted data CK3(D2) obtained by encrypting the output value D2 with the common key CK3 to the output destination server 202z.

As described above, the FPGA 300z needs to individually perform a process of generating the common keys CK1 to CK3, verifying signatures of the common keys CK1 to CK3, or performing encryption using the common keys CK1 to CK3 for each destination device. Since the processing load is imposed on the FPGA 300z, even in a case where a process of calculating the output value D2 is offloaded to the FPGA 300z, the processing efficiency is reduced.

Therefore, a main object of the present invention is to reduce a load in a case where the same calculation result is transmitted to a plurality of destinations in a reliable manner.

### Solution to Problem

In order to solve the above problems, a calculation result distribution device of the present invention has the following features. According to the present invention, there is provided a calculation result distribution device including
a common key distributer that generates a common key shared by a plurality of destination devices, generates, for each of the destination devices, first encrypted data obtained by encrypting the common key by using a public key paired with a secret key individually possessed by each of the destination devices, and distributes the generated first encrypted data to each of the destination devices, thereby causing each of the destination devices to decrypt the common key; and
a data output circuit that distributes second encrypted data obtained by encrypting a calculation result by using the common key to each of the destination devices, thereby causing each of the destination devices to decrypt the calculation result.

### Advantageous Effects of Invention

According to the present invention, it is possible to reduce a load in a case where the same calculation result is transmitted to a plurality of destinations in a reliable manner.

### BRIEF DESCRIPTION OF DRAWINGS

FIG. 1 is a configuration diagram of a calculation result protection system according to the present embodiment.

FIG. 2 is an explanatory diagram illustrating processing of an input value and an output value according to the present embodiment.

FIG. 3 is an explanatory diagram illustrating a common key distribution process of a common key distributer according to the present embodiment.

FIG. 4 is an explanatory diagram illustrating an output value distribution process of a data output circuit according to the present embodiment.

FIG. 5 is a configuration diagram of a case where a protection region is provided in a destination device of an output value as a modified example of the calculation result protection system according to the present embodiment.

FIG. 6 is an explanatory diagram illustrating a common key distribution process of the case in FIG. 5 according to the present embodiment.

FIG. 7 is an explanatory diagram illustrating an output value distribution process in the case in FIG. 5 according to the present embodiment.

FIG. 8 is a sequence diagram illustrating a process of checking in advance that a destination device of an output value according to the present embodiment is a reliable partner.

FIG. 9 is a sequence diagram illustrating a common key distribution process according to the present embodiment.

FIG. 10 is a sequence diagram illustrating an output value distribution process according to the present embodiment.

FIG. 11 is a table illustrating a list of certificates issued by a CA as a third-party organization according to the present embodiment.

FIG. 12 is a table illustrating a list of reliable communication partners included in a management server according to the present embodiment.

FIG. 13 is a table illustrating a list of communication partners included in each device other than a management server, such as an input device according to the present embodiment.

FIG. 14 is a table illustrating a list of destination devices of output values included in the management server according to the present embodiment.

FIG. 15 is a table illustrating a list of common keys included in the management server according to the present embodiment.

FIG. 16 is a hardware configuration diagram of each device of the calculation result protection system according to the present embodiment.

FIG. 17 is an explanatory diagram illustrating output value distribution process.

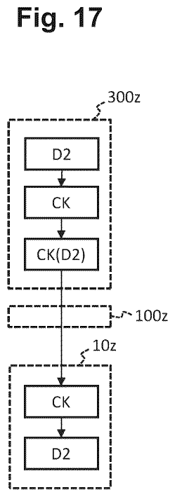

FIG. 18 is an explanatory diagram of a case where there are a plurality of destination devices of output values.

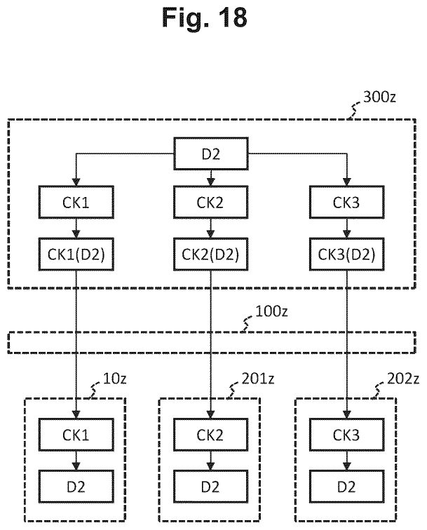

FIG. 19 is an explanatory diagram of a case where an FPGA executes an encryption process instead of the management server as a modified example related to FIG. 4 according to the present embodiment.

### DESCRIPTION OF EMBODIMENTS

Hereinafter, an embodiment of the present invention will be described in detail with reference to the drawings.

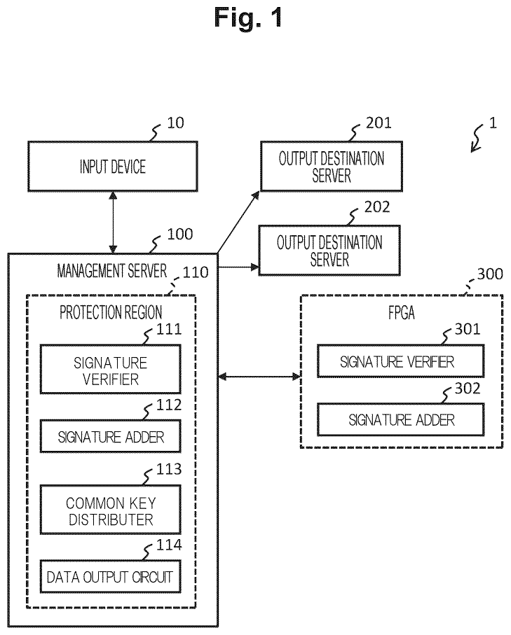

FIG. 1 is a configuration diagram of a calculation result protection system 1.

The calculation result protection system 1 is configured by connecting an input device 10, a management server (calculation result distribution device) 100, an FPGA (offload destination device) 300, an output destination server 201, and an output destination server 202 via a network.

The input device 10 requests the management server 100 to perform a process (hereinafter, an offload process) of calculating an output value D2 (calculation result) from an input value D1 as a process of offloading to the FPGA 300. That is, the input device 10 transmits the input value D1 to the management server 100.

Note that an offload destination device is not limited to the FPGA 300, and any device, such as those exemplified below, may be used.
Graphics processing unit (GPU)
Floating point unit (FPU)
Digital signal processor (DSP)

The management server 100 offloads the offload process received from the input device 10 to the FPGA 300. The FPGA 300 returns an output value D2 obtained by executing the received offload process to the management server 100. The management server 100 distributes the output value D2 obtained from the FPGA 300 to a destination device. In FIG. 1, destination devices are a total of three devices including the input device 10, the output destination server 201, and the output destination server 202. The management server 100 checks a detailed state of a destination device.

Note that the offload process is, for example, a process of setting information of a device for verifying security as the input value D1 and calculating the output value D2 such as a security reliability score from the input value D1. That is, since both the input value D1 and the output value D2 are important information for which reliability is required, such as ensuring that data content is not falsified, it is necessary to prepare a signature indicating a calculation subject who has performed the calculation together.

Thus, a protection region (first protection region) 110 is prepared in a memory of the management server 100.

The protection region 110 protects stored data from unauthorized data access. That is, the protection region 110 is a region (enclave) that is prepared in the memory of the management server 100 and in which the data access right is protected, and data can be protected by narrowing down the access right to some applications.

The protection region 110 is prepared for the purpose of preventing even software having weak authority from being infringed when software having strong authority is attacked. Examples of the software having strong authority include an operating system (OS), a driver, a basic input output system (BIOS), and a virtual machine manager (VMM).

Note that the management server 100 configures a protection region 110 that can execute programs for signature, encryption, and the like while protecting information. The protection region 110 is, for example, a location where integrity can be secured by adding a signature/signature verification program. The protection region 110 is an isolated location with limited access authority, and confidentiality can also be secured by adding an encryption program.

It is desirable that all internal data is securely protected, but even if the internal data is not completely protected, the protection region 110 can be used even in a case where confidential information (such as a secret key in a public key cryptosystem) of the internal data is securely protected.

Specifically, a signature verifier 111, a signature adder 112, a common key distributer 113, and a data output circuit 114 are configured in the protection region 110 of the management server 100, and data used for processing of these processing units is stored in the protection region 110.

The signature verifier 111 refers to, for example, device information of another device transmitted from the other device, and determines that the verification is passed in a case where the other device has a protection region (data protection capability). The destination device that has passed the verification is a distribution target of the output value D2. As a result, it is guaranteed that the information transmitted from the management server 100 to the other device is stored in the protection region in the other device, and thus, it is possible to prevent information leakage from the other device that is a destination device before distribution.

The device information of the other device is, for example, information used for attestation which is a technology for checking the capability of the protection region or the like, such as address information of the protection region of the other device or information of an application in the protection region.

The signature verifier 111 may verify the reliability of another device (such as the input device 10) that is a communication partner of the management server 100 by verifying a signature of the other device. Thus, the signature verifier 111 verifies a signature applied to at least one of pieces of information exemplified below.
A certificate issued by a third-party organization (CA), or a public key of another device included in the certificate
Random number information issued from another device
Address information (an IP address or the like) of another device
Device information of another device associated with a public key of another device

The signature adder 112 adds a signature for causing another device to check the reliability of the management server 100 itself. Note that, as to what kind of information a signature is added to, each piece of information of another device verified by the signature verifier 111 may be replaced with each piece of information of the management server 100.

The common key distributer 113 generates a common key shared by a plurality of communication partners used to encrypt an output value (calculation result) of the FPGA 300, and distributes the common key to other devices.

That is, the common key distributer 113 generates the common key CK shared by a plurality of destination devices (such as the input device 10). The common key distributer 113 generates, for each destination device, first encrypted data obtained by encrypting the common key CK by using a public key PK paired with a secret key SK individually possessed by each destination device. The common key distributer 113 distributes the generated first encrypted data to each destination device, thereby causing each destination device to decrypt the common key CK.

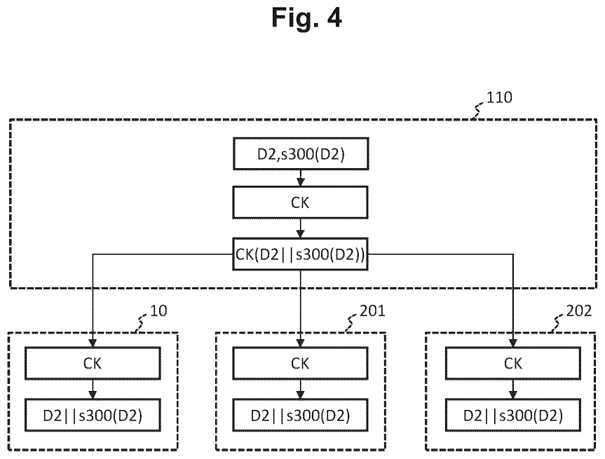

The data output circuit 114 generates second encrypted data obtained by encrypting the output value D2 (calculation result) of the FPGA 300 by using the common key CK generated by the common key distributer 113 (details thereof will be described in FIG. 4). The data output circuit 114 distributes the generated second encrypted data to each destination device, thereby causing each destination device to decrypt the output value D2.

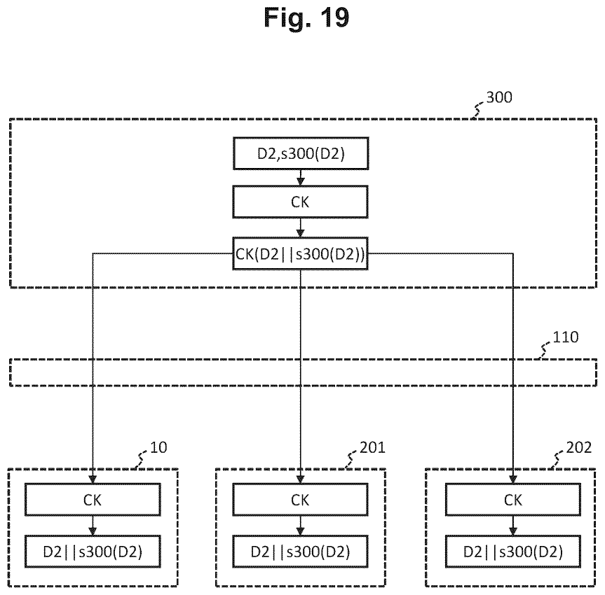

Alternatively, the common key CK generated by the common key distributer 113 may be transmitted to the FPGA 300, and the second encrypted data obtained by encrypting the output value D2 may be generated on the FPGA 300 (details thereof will be described in FIG. 19).

The FPGA 300 includes a signature verifier 301 and a signature adder 302.

The signature verifier 301 verifies the management server 100 by verifying a signature added by the signature adder 112 of the management server 100 that is an offload source.

The signature adder 302 adds a signature for causing another device to confirm the reliability of the FPGA 300 to the output value of the FPGA 300.

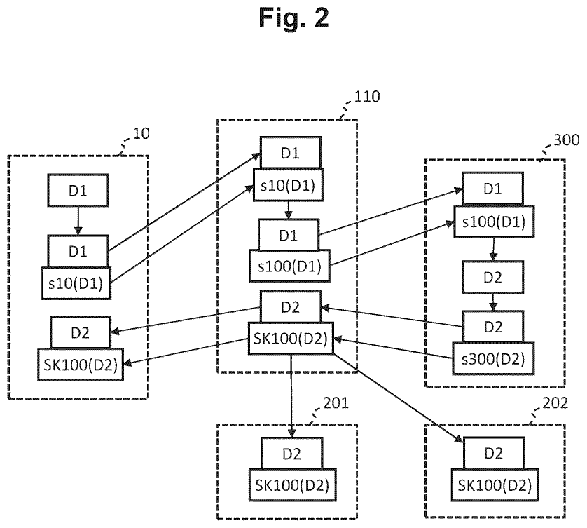

FIG. 2 is an explanatory diagram illustrating processing of the input value D1 and the output value D2.

The input device 10 creates a signature s10(D1) for the prepared input value D1 by using an own key s10. The input device 10 transmits the input value D1 and the signature s10(D1) to the protection region 110 of the management server 100.

The signature verifier 111 of the protection region 110 verifies the signature s10(D1). The signature adder 112 replaces the signature s10(D1) that has passed the verification of the signature verifier 111 with a signature s100(D1) using the own key s100. The signature adder 112 requests the FPGA 300 to perform an offload process of the input value D1 together with the signature s100(D1).

The signature verifier 301 of the FPGA 300 verifies the requested signature s100(D1) of the offload process. The FPGA 300 obtains the output value D2 by calculating the offload process on the basis of the input value D1 of the signature s100(D1) that has passed the verification of the signature verifier 301.

The signature adder 302 creates a signature s300(D2) for the calculated output value D2 by using an own key s300. The FPGA 300 transmits the output value D2 and the signature s300(D2) to the protection region 110 of the management server 100.

The signature verifier 111 verifies the received output value D2 and the signature s300(D2). The signature adder 112 replaces the signature s300(D2) that has passed the verification with a signature SK100(D2).

The data output circuit 114 distributes the output value D2 and the signature SK100(D2) to the input device 10 as a destination device, the output destination server 201, and the output destination server 202.

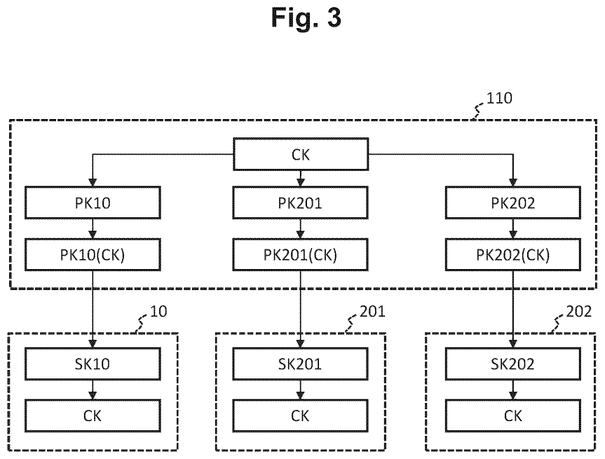

FIG. 3 is an explanatory diagram illustrating a distribution process of the common key CK performed by the common key distributer 113.

The common key distributer 113 distributes the common key CK shared by the plurality of destination devices according to the following procedures in order to perform encryption associated with the distribution process of the output value D2 illustrated in FIG. 2.

(Procedure 1) The common key distributer 113 acquires in advance a public key PK10 of the input device 10, a public key PK201 of the output destination server 201, and a public key PK202 of the output destination server 202 from a CA, the destination devices, and the like as the verified public key PK for each destination device.

(Procedure 2) The common key distributer 113 generates one common key CK shared by a plurality of destination devices.

(Procedure 3) The common key distributer 113 generates a plurality of pieces of encrypted data obtained by encrypting the common key CK with the public key PK for each destination device. For example, encrypted data PK10(CK) for the input device 10 is obtained by encrypting the common key CK with the public key PK10 of the input device 10.

(Procedure 4) The common key distributer 113 distributes the plurality of pieces of generated encrypted data to the respective destination devices. For example, the encrypted data PK10(CK) is distributed to the input device 10, encrypted data PK201(CK) is distributed to the output destination server 201, and encrypted data PK202(CK) is distributed to the output destination server 202.

(Procedure 5) Each destination device acquires the common key CK in Procedure 2 by decrypting the distributed encrypted data by using the own secret key SK paired with the public key PK in Procedure 1. For example, the input device 10 acquires the common key CK in Procedure 2 by decrypting the distributed encrypted data PK10(CK) by using the own secret key SK10.

According to the above procedures, one common key CK generated by the management server 100 is safely distributed from the protection region 110 to each destination device. Since the management server 100 only needs to generate one common key CK regardless of the number of destination devices, the load is reduced.

FIG. 4 is an explanatory diagram illustrating a distribution process of the output value D2 performed by the data output circuit 114.

The data output circuit 114 can secure the safety of the output value D2 by encrypting the output value D2 by using the common key CK illustrated in FIG. 3 according to the following procedures and distributing the output value D2.

(Procedure 1) The data output circuit 114 receives the output value D2 received from the FPGA 300 that is an offload destination and the signature s300(D2). Hereinafter, the entire data obtained by connecting the received output value D2 and the signature s300(D2) is indicated by a symbol “∥”, such as “D2∥s300(D2)”.

(Procedure 2) The data output circuit 114 acquires encrypted data CK(D2∥s300(D2)) by encrypting the data D2∥s300(D2) by using the common key CK.

(Procedure 3) The data output circuit 114 distributes the encrypted data CK(D2∥s300(D2)) to each destination device.

(Procedure 4) Each destination device such as the input device 10 decrypts the data D2∥s300(D2) from the encrypted data CK(D2∥s300(D2)) by using the common key CK. Each destination device verifies the output value D2 and the signature s300(D2).

As described above, even if there are a plurality of destination devices, the data output circuit 114 may perform encryption using the distributed common key CK once. Therefore, even if the number of destination devices increases, the trouble of encryption does not increase.

FIG. 19 is an explanatory diagram of a case where the FPGA 300 performs encryption instead of the management server 100 as a modified example related to FIG. 4. (Procedure 1) and (Procedure 2) in FIG. 4 are replaced with the following (Procedure 1B) and (Procedure 2B). After (Procedure 2B), (Procedure 3) and (Procedure 4) are executed as in FIG. 4.

(Procedure 1B) The FPGA 300 acquires the encrypted data CK(D2∥s300(D2)) by encrypting the data D2∥s300(D2) by using the common key CK received from the management server 100.

(Procedure 2B) The data output circuit 114 receives the encrypted data CK(D2∥s300(D2)) from the FPGA 300 that is an offload destination.

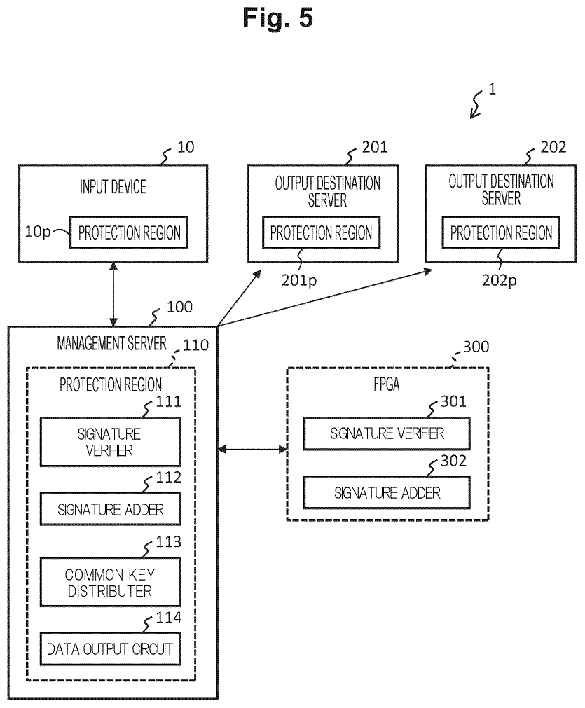

FIG. 5 is a configuration diagram of a case where a protection region (second protection region) is provided in the destination device of the output value D2 as a modified example of the calculation result protection system 1.

As compared with the calculation result protection system 1 in FIG. 1, respective devices (the input device 10, the output destination server 201, and the output destination server 202) that are destination devices of the output value D2 have protection regions 10p, 201p, and 202p therein.

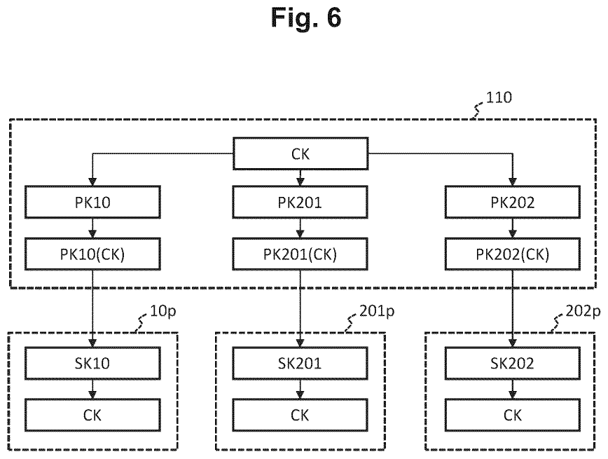

FIG. 6 is an explanatory diagram illustrating a process of distributing the common key CK in the case in FIG. 5. In FIG. 5, the process of decrypting the common key CK in (Procedure 5) in FIG. 3 is changed to be performed in the protection region of each device.

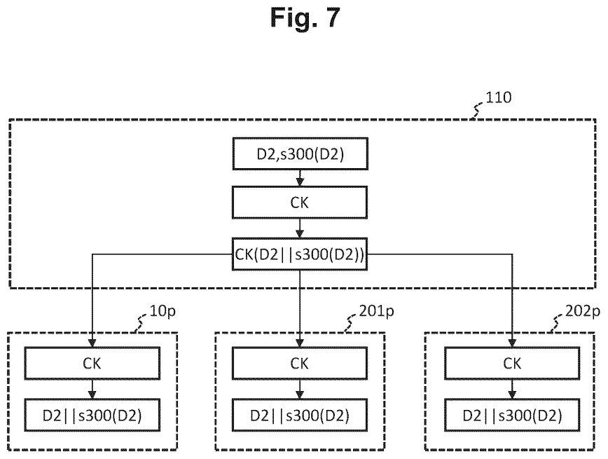

FIG. 7 is an explanatory diagram illustrating a distribution process of the output value D2 in the case in FIG. 5. In FIG. 5, the process of decrypting the encrypted data CK(D2∥s300(D2)) in (Procedure 4) in FIG. 4 is changed to be performed in the protection region of each device.

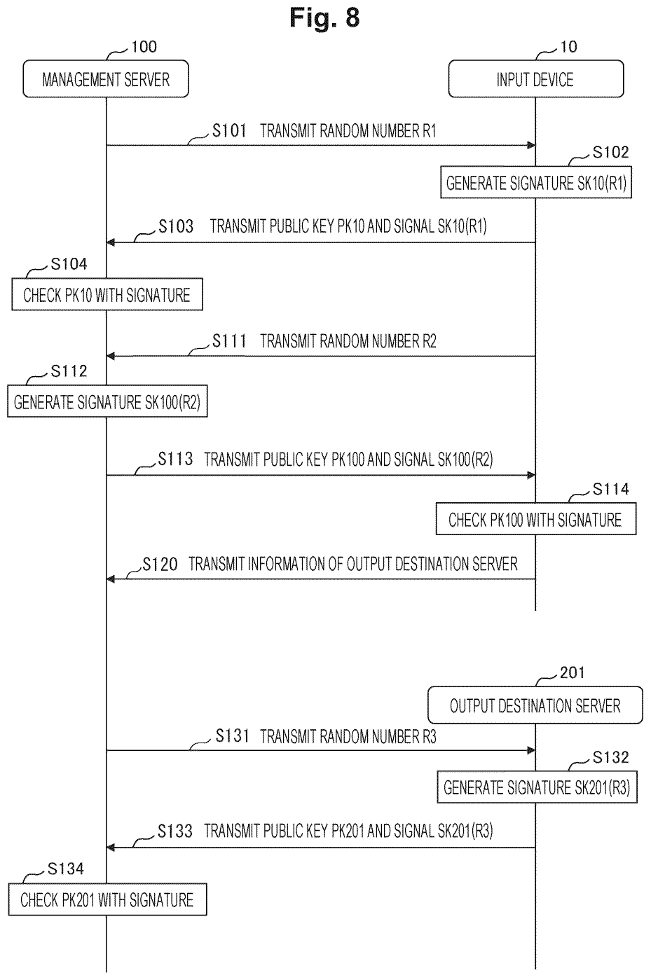

As described above, with the configurations in FIGS. 5 to 7, the output value D2 can be prevented from being illegally accessed from the outside, and thus the security strength is improved. Hereinafter, details of the processes in FIGS. 2 to 4 will be described with reference to FIGS. 8 to 16.

FIG. 8 is a sequence diagram illustrating a process of checking in advance that a destination device of the output value D2 is a reliable partner.

In this sequence diagram, each device of the calculation result protection system 1 checks other devices on the basis of challenge and response authentication without directly exchanging confidential information such as a password.

First, the management server 100 checks the public key PK10 of the input device 10 in S101 to S104.

Specifically, the management server 100 transmits a random number R1 to the input device 10 (S101). The input device 10 generates a signature SK10(R1) by using the own secret key SK10 for the random number R1 (S102).

The input device 10 transmits the own public key PK10 and signature SK10(R1) to the management server 100 (S103). The signature verifier 111 of the management server 100 checks the transmitted public key PK10 with the signature SK10(R1) (S104). In a case where the checking in S104 is successful, the processing proceeds to the next S111.

On the other hand, in a case where the checking in S104 fails, an error message is returned to the input device 10 that is a communication partner. Also, in each of the following processes, in a case where checking of a signature fails, an error message is returned to a communication partner.

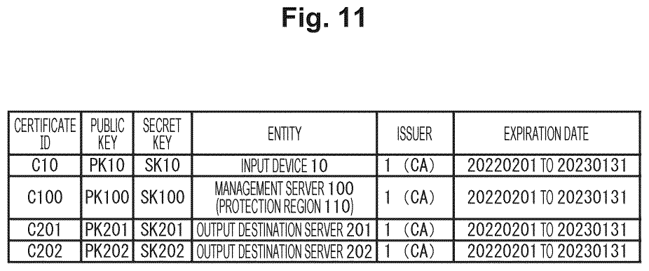

FIG. 11 is a table illustrating a list of certificates issued by a CA as a third-party organization.

In this table, a certificate ID, a public key included in a certificate, a secret key paired with the public key, an entity that manages the secret key, an issuer that is a CA that issues the certificate, and an expiration date of the certificate are associated with each other. Each device (for example, the management server 100) of the calculation result protection system 1 can acquire a public key (for example, the public key PK10 of the input device 10) of which reliability is guaranteed within an expiration date by a certificate from the CA.

The certificate is used in an environment called a public key infrastructure (PKI). In the PKI, by using various encryption technologies such as RSA encryption and elliptic curve encryption, authentication and attestation of a communication partner can be performed on the basis of a guarantee of a certificate issuance destination by a third-party organization (CA).

Each device obtains an own certificate and a pair of a secret key and a public key attached to the certificate from the CA in advance. Alternatively, each device creates a pair of a public key and secret key, and obtains a certificate using the public key from the CA in advance. On the other hand, a public key of another device is transmitted to the other device instead of being obtained from the CA.

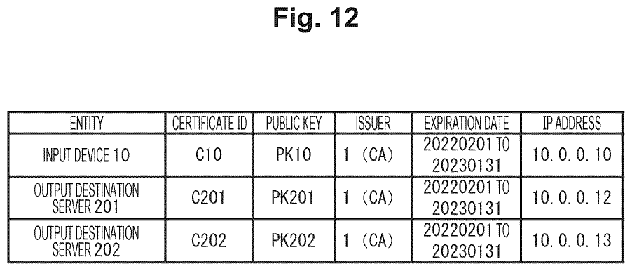

FIG. 12 is a table illustrating a list of reliable communication partners included in the management server 100.

In this table, in addition to the respective items (a certificate ID, a public key, an entity, an issuer, and an expiration date) described in FIG. 11, an IP address of a device of the entity is correlated as device information associated with the public key. That is, device information of another device, an address (not illustrated) of a protection region of the other device, information (not illustrated) of an application in the protection region, and the like can also be checked through the process in S114 or the process in S134 that will be described later by using a column of entities of the other device as a search key.

The table includes entries of the output destination servers 201 and 202 reported in S120 that will be described later in addition to the entry of the input device 10 checked in S101 to S104. Note that the state of the table in FIG. 12 is a state after the output destination servers 201 and 202 are checked through S131 to S134 that will be described below.

Returning to FIG. 8, the input device 10 checks the public key PK100 of the management server 100 in S111 to S114.

Specifically, the input device 10 transmits a random number R2 to the management server 100 (S111). The signature adder 112 of the management server 100 generates a signature SK100(R2) by using the own secret key SK100 for the random number R2(S112).

The management server 100 transmits the own public key PK100 and signature SK100(R2) to the input device 10 (S113). The input device 10 checks the transmitted public key PK100 with the signature SK100(R2) (S114). The input device 10 transmits information of the output destination servers 201 and 202 that needs to be checked to the management server 100 (S120).

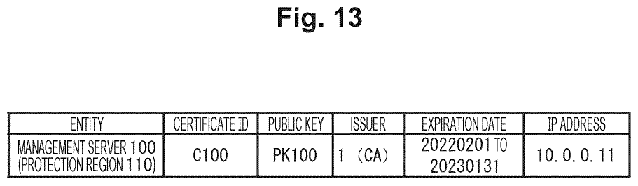

FIG. 13 is a table illustrating a list of communication partners included in each device other than the management server 100, such as the input device 10. This table has the same data format as that in FIG. 12. Similarly to FIG. 12, as a result of S111 to S114, an entry of the management server 100, which is a reliable partner of the input device 10, is registered in the table in FIG. 13.

Returning to FIG. 8, the management server 100 checks the public key PK201 of the output destination server 201 in S131 to S134. Note that, although not illustrated, the same applies to processing in which the management server 100 checks the public key PK202 of the output destination server 202.

The management server 100 transmits a random number R3 to the output destination server 201 (S131). The output destination server 201 generates a signature SK201(R3) by using the own secret key SK201 for the random number R3(S132).

The output destination server 201 transmits the own public key PK201 and the signature SK201(R3) to the management server 100 (S133). The signature verifier 111 of the management server 100 checks the transmitted public key PK201 with the signature SK201(R3) (S134).

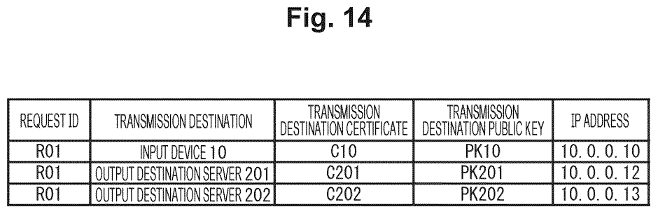

FIG. 14 is a table illustrating a list of destination devices of the output value D2 included in the management server 100. In this table, a request ID issued for each destination device of the same output value D2, a transmission destination indicating a destination device of the same output value D2, information (an ID of a certificate and a public key of a transmission destination of the certificate) in FIG. 11 issued to the transmission destination, and an IP address in FIG. 12 are associated with each other.

For example, three devices (the input device 10, the output destination server 201, and the output destination server 202) having the same request ID of “R01” are a set to be destination devices of the same output value D2. The management server 100 sequentially adds the devices checked in the processing in FIG. 8 to the table in FIG. 14.

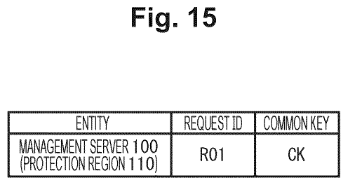

FIG. 15 is a table illustrating a list of common keys CK included in the management server 100. The common key CK issued for each request ID in FIG. 14 is registered in this table.

If it is desired to distribute the output value D3 to two devices (the input device 10 and the output destination server 201) separately from a destination device of the output value D2, the management server 100 may add a combination of a new request ID “R02”, the destination device, and the new common key CK2 issued for R02 to the table in FIG. 14 and the table in FIG. 15.

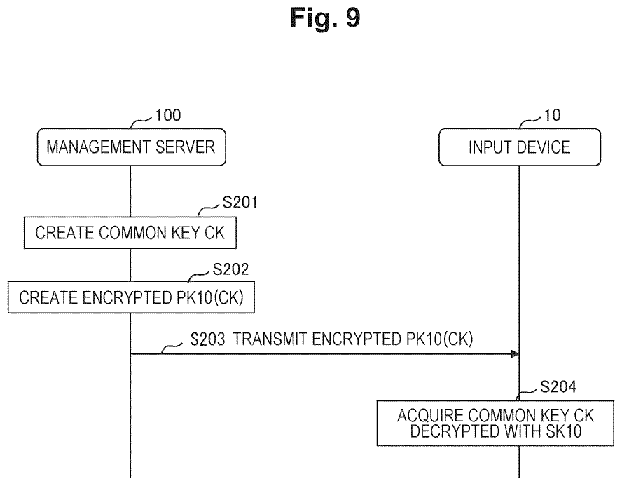

FIG. 9 is a sequence diagram illustrating a distribution process of the common key CK.

The management server 100 creates the common key CK shared by the plurality of destination devices (S201). The management server 100 creates the encrypted data PK10(CK) obtained by encrypting the common key CK by using the public key PK10 of the input device 10 checked in FIG. 8 (S202). The management server 100 transmits the encrypted data PK10(CK) to the input device 10 (S203).

The input device 10 acquires the common key CK by decrypting the encrypted data PK10(CK) with the own secret key SK10 (S204).

The above processing is processing in a case where the input device 10 is set as a destination device, but S202 to S204 are executed for each destination device of the output value D2. As described below, other destination devices similarly execute the processing in FIG. 9.

[Destination device=output destination server 201 in S203] The public key PK10 used to create the encrypted data in S202 is replaced with the public key PK201 of the output destination server 201 checked in FIG. 8. The secret key SK10 used to decrypt the encrypted data in S204 is replaced with the secret key SK201 of the output destination server 201.

[Destination device=output destination server 202 in S203] The public key PK10 used to create the encrypted data in S202 is replaced with the public key PK202 of the output destination server 202 checked in FIG. 8. The secret key SK10 used to decrypt the encrypted data in S204 is replaced with the secret key SK202 of the output destination server 202.

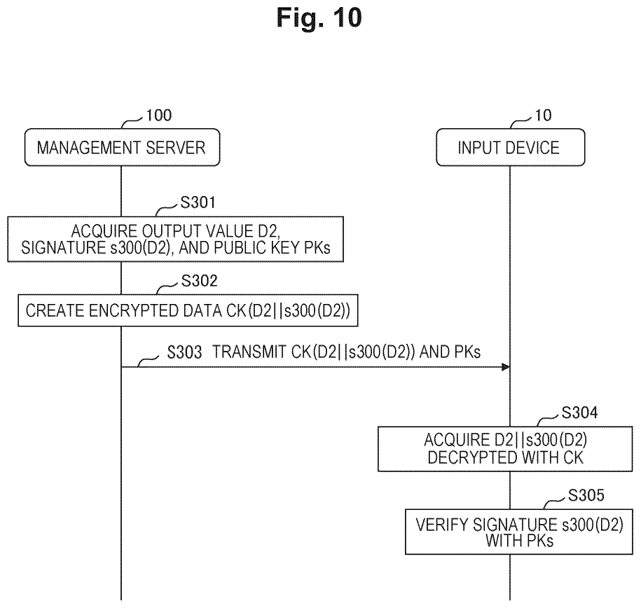

FIG. 10 is a sequence diagram illustrating a distribution process of the output value D2.

The management server 100 acquires the output value D2, the signature s300(D2), and a verification public key PKs from the FPGA 300 that is an offload destination (S301). Therefore, in the FPGA 300, a secret key SKs for generating the signature s300(D2) and a public key PKs for verification thereof are prepared in advance.

The management server 100 creates encrypted data CK(D2∥s300(D2)) by encrypting the data D2∥s300(D2) by using the common key CK(S302). The management server 100 transmits the encrypted data CK(D2∥s300(D2)) and the public key PKs to the input device 10 (S303).

The input device 10 decrypts and acquires the data D2∥s300(D2) from the encrypted data CK(D2∥s300(D2)) by using the common key CK(S304). The input device 10 decrypts the signature s300(D2) with the public key PKs and verifies whether or not the signature is valid as a signature of the output value D2(S305). In a case where the signature is successfully checked in S305, it can be checked that the data has not been falsified.

The above processing is processing in a case where the input device 10 is set as a destination device, but S303 and S304 are executed for each destination device (the output destination server 201 and the output destination server 202) of the output value D2.

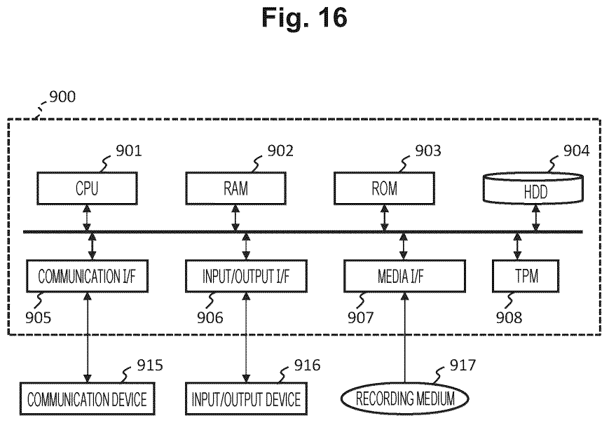

FIG. 16 is a hardware configuration diagram of each device of the calculation result protection system 1.

Each device of the calculation result protection system 1 is configured as a computer 900 including a CPU 901, a RAM 902, a ROM 903, an HDD 904, a communication I/F 905, an input/output I/F 906, a media I/F 907, and a trusted platform module (TPM) 908.

The communication I/F 905 is connected to an external communication device 915. The input/output I/F 906 is connected to an input/output device 916. The media I/F 907 reads and writes data from and to a recording medium 917. The CPU 901 controls each unit by executing a program (also referred to as an application or an app for abbreviation thereof) read into the RAM 902. The program may be distributed via a communication line or distributed by being recorded in the recording medium 917 such as a CD-ROM.

The TPM 908 is used, for example, to form a protection region in the RAM 902.

### Effects

The management server 100 of the present invention includes
the common key distributer 113 that generates the common key CK shared by a plurality of destination devices (such as the input device 10), generates, for each destination device, the encrypted data PK10(CK) obtained by encrypting the common key CK by using the public key PK paired with the secret key SK individually possessed by each destination device, and distributes the generated encrypted data PK10(CK) for each destination device, thereby causing each destination device to decrypt the common key CK; and
the data output circuit 114 that distributes, for each destination device, the encrypted data CK(D2) obtained by encrypting the output value D2 by using the common key CK, thereby causing each destination device to decrypt the output value D2.

As a result, since the same common key CK is used when data is sent to a plurality of destination devices, the management server 100 does not need to generate and store the plurality of common keys CK. Therefore, management cost of security resources can be reduced through the integrated management of the common key CK. A processing load on the FPGA 300 that calculates the output value D2 can be reduced.

Since the encryption process and the decryption process using the common key CK have less load than the encryption process and the decryption process using the secret key SK and the public key PK, the encryption process and the decryption process of the output value D2 with high frequency can be executed with low load. Therefore, it is possible to reduce a load in a case where the same calculation result is transmitted to a plurality of destinations in a reliable manner.

In the present invention, the management server 100 includes a protection region 110 for protecting stored data from unauthorized data access, and
data used for processing of the common key distributer 113 and data used for processing of the data output circuit 114 are stored in the protection region 110.

As a result, an encryption key such as the common key CK is securely stored in the protection region 110 in the management server 100.

In the present invention, the calculation result protection system 1 has the management server 100 and a destination device,
at least some destination devices have the protection region 10p for protecting stored data from unauthorized data access,
the management server 100 further includes the signature verifier 111 that verifies each destination device in the protection region 110, and
the signature verifier 111 verifies whether or not the destination device has the protection region 10p with reference to device information of the destination device, determines that the destination device having the protection region 10p has passed the verification, and distributes the generated encrypted data PK10(CK) to the destination device that has passed the verification.

As a result, in a case where information with high confidentiality is transmitted from the management server 100 to another device, it is guaranteed in advance that the information with high confidentiality is stored in the protection region in the other device. Therefore, information leakage from another device that is a destination device can be prevented before distribution.

In the present invention, the calculation result protection system 1 further includes an FPGA 300 that calculates the output value D2,
the FPGA 300 transmits the calculated output value D2 and the own signature to the management server 100,
the data output circuit 114 distributes the encrypted data CK(D2) and the signature of the FPGA 300 to each destination device, and
the destination device verifies the output value D2 obtained by decrypting the encrypted data CK(D2) and the signature of the FPGA 300 in the protection region 10p.

Consequently, it is possible to guarantee that the output value D2 is a calculation result from the FPGA 300, and even if falsification of the output value D2 occurs, the falsification can be appropriately detected.

### Reference Signs List

1 Calculation result protection system
10 Input device (destination device)
10p Protection region (second protection region)
100 Management server (calculation result distribution device)
110 Protection region (first protection region)
111 Signature verifier (verifier)
112 Signature adder
113 Common key distributer
114 Data output circuit
201 Output destination server (destination device)
201p Protection region (second protection region)
202 Output destination server (destination device)
202p Protection region (second protection region)
300 FPGA (offload destination device)
301 Signature verifier
302 Signature adder

1. A calculation result distribution device comprising:
a common key distributer that generates a common key shared by a plurality of destination devices, generates, for each of the destination devices, first encrypted data obtained by encrypting the common key by using a public key paired with a secret key individually possessed by each of the destination devices, and distributes the generated first encrypted data to each of the destination devices, thereby causing each of the destination devices to decrypt the common key; and
a data output circuit that distributes second encrypted data obtained by encrypting a calculation result by using the common key to each of the destination devices, thereby causing each of the destination devices to decrypt the calculation result.

2. The calculation result distribution device according to claim 1, wherein
the calculation result distribution device includes a first protection region for protecting stored data from unauthorized data access, and
data used for processing of the common key distributer and data used for processing of the data output circuit are stored in the first protection region.

3. A calculation result protection system comprising: the calculation result distribution device according to claim 2; and the destination devices, wherein
at least some of the destination devices have a second protection region for protecting stored data from unauthorized data access, and
the calculation result distribution device further includes a verifier that verifies each of the destination devices in the first protection region, and
the verifier verifies whether or not the destination device has the second protection region with reference to device information of the destination device, determines that the destination device having the second protection region has passed the verification, and distributes the generated first encrypted data to the destination device that has passed the verification.

4. The calculation result protection system according to claim 3, further comprising an offload destination device that calculates the calculation result, wherein
the offload destination device transmits the calculated calculation result and an own signature to the calculation result distribution device,
the data output circuit distributes the second encrypted data and the signature of the offload destination device to each destination device, and
the destination device verifies the calculation result obtained by decrypting the second encrypted data and the signature of the offload destination device in the second protection region.

5. A calculation result distribution method for a calculation result distribution device including a common key distributer and a data output circuit, the calculation result distribution method comprising:
a common key distribution step of generating a common key shared by a plurality of destination devices, generating, for each of the destination devices, first encrypted data obtained by encrypting the common key by using a public key paired with a secret key individually possessed by each of the destination devices, and distributing the generated first encrypted data to each of the destination devices, thereby causing each of the destination devices to decrypt the common key; and
a data output step of distributing second encrypted data obtained by encrypting a calculation result by using the common key to each of the destination devices, thereby causing each of the destination devices to decrypt the calculation result.
